(19) United States
(12) Patent Application Publication
(10) Pub. No.: US 2006/0165327 A1
(43) Pub. Date: Jul. 27, 2006

(54) Oil carrying bearing

(76) Inventors: Mou-Kun Chen, Taipei County (TW); Yen-Fu Liao, Taipei County (TW)

Correspondence Address: Mou-Kun Chen & Yen-Fu Liao, P.O. Box No. 6-57, Junghe, Taipei, 235, TW

(21) Appl. No.: 11/134,436

(22) Filed: May 23, 2005

(30) Foreign Application Priority Data
Jan. 12, 2005 (TW) 094200665

(51) Int. Cl. F16C 33/10

(52) U.S. Cl. 384/397

(57) ABSTRACT

An oil carrying bearing includes a single bearing having oil storage ports and an interior of the bearing is defined a shaft hole. Width of a cross-sectional area of each of the ports is smaller than diameter of the shaft hole, thereby enabling a shaft to be supported by a relatively large support prop surface. The ports can be further adopted with inclined surfaces that provide the ports with a tapered expanded form, thereby forming a compression or yield space for the stored oil, which, because of a centrifugal force effect of the rotating shaft, controls discharge of oil and guides distribution flow to the shaft. Furthermore, outward port openings of the ports are sealed with end-seal members thereby effectively achieving complete encasing of an exterior portion of the bearing, preventing oil from leaking out.

### BACKGROUND OF THE INVENTION

(a) Field of the Invention

The present invention relates to an improved structure for an oil carrying bearing, and more particularly to an oil carrying structure for a light load high speed bearing, primarily using symmetrical oil storage ports radially penetrating inward an outer surface of the bearing. Cross-sectional area of each of the ports is smaller than diameter of a shaft hole. Moreover, a plurality of the ports can be defined to provide uniform distribution of an oil film.

(b) Description of the Prior Art

Conventional light load high speed bearings have particular application in electronic related peripheral equipment, including turntable type disk drives, CPU heat dissipating fans, and so on. In order to meet high rotating speed demands and comply with conditions requiring low noise, narrow space restrictions, and so on, miniature bearings are necessarily used in conjunction with rotating shafts. Furthermore, lubrication is necessarily provided in order to reduce friction generated when rotating.

Regarding bearing prior art, patent No. 554970, entitled “Hollow Structure for Ceramic Bearing”, discloses a bearing structure as depicted in FIG. 1, which shows a bearing of the cited patent primarily structured to comprise a single bush 2, a center of which is defined a shaft hole that provides for a shaft 1 to be disposed therein. A cavity 21 is defined on an outer surface of the bush 2, and width of the cavity 21 is larger than diameter of the shaft 1. Moreover, an 180° ∠ semi-annular groove 22 is formed around a periphery of the shaft 1. Such a design realizes an evident reduction in pivot connection surfaces 23 of the bush 2 supporting the shaft 1, and, because of the small areas of contact of the pivot connection surfaces 23, thus, strength of the entire structure is substantially inadequate, and easily results in shortening serviceable life of the structure or the structure being damaged.

Furthermore, regarding production method of the aforementioned cited patent, a mold is necessarily used to produce the cavity 21 because of its concave form, which a conventional machine tool is unable to produce, thus, resulting in manufacturing materials being correspondingly subjected to restrictions imposed by conditions required for injection molding, bringing about the inability to effectively increase production output and decrease manufacturing costs.

Hence, in light of the aforementioned shortcomings, the inventor of the present invention, having accumulated years of experience in related arts, and carrying out extensive study and exploration endeavoring for perfection, applied professional insight and knowledge to ultimately design an improved structure for an oil carrying bearing.

### SUMMARY OF THE INVENTION

Hence, a primary objective of the present invention is to provide an improved structure for an oil carrying bearing, wherein oil storage ports radially penetrate a single bearing, and width of a cross-sectional area of each of the ports is smaller than diameter of a shaft hole, thereby enabling a shaft to be supported by a relatively large support surface. In addition, a plurality of the ports can be defined on the bearing to provide a uniform distribution of lubricating oil. Furthermore, an increase in strength of the integral configuration is achieved through a simple and convenient machining procedure.

Another objective of the present invention is to define a plurality of the ports in longitudinal reciprocal or staggered fashion on the bearing, thereby enabling multidirectional uniform distribution of the lubricating oil via lubricating oil contact surfaces.

A third objective of the present invention is to define the oil storage ports so as to radially penetrate an outer surface of the bearing, thus volume of oil storage is relatively large. Moreover, outward port openings of the oil storage ports are sealed with end-seal members, thereby achieving objective of preventing the oil from leaking out.

A fourth objective of the present invention is to adopt an outward expanded tapered form for the ports, thereby forming a compression or yield space for the stored oil, which can counteract a centrifugal effect of the rotating shaft, and further controls discharge of oil and guides distribution flow to the shaft.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational schematic view of a conventional bearing.

FIG. 2 shows a cutaway view according to the present invention.

FIG. 3 shows a cutaway view of the present invention used as a radial bearing.

FIG. 4 shows an elevational schematic view of a plurality of ports longitudinally distributed in a staggered fashion on a bearing according to the present invention.

FIG. 5 shows a top view of FIG. 4 according to the present invention.

FIG. 6 shows a cutaway view of a plurality of the ports complementary positioned on the bearing to achieve a complete continuity of contact surfaces.

FIG. 7 shows a schematic view of ports of square and rectangular cross-section defined on the bearing according to the present invention.

FIG. 8 shows a schematic view of ports of elongated oval cross-section defined on the bearing according to the present invention.

FIG. 9 shows a cutaway view of tapered ports having inclined surfaces according to the present invention.

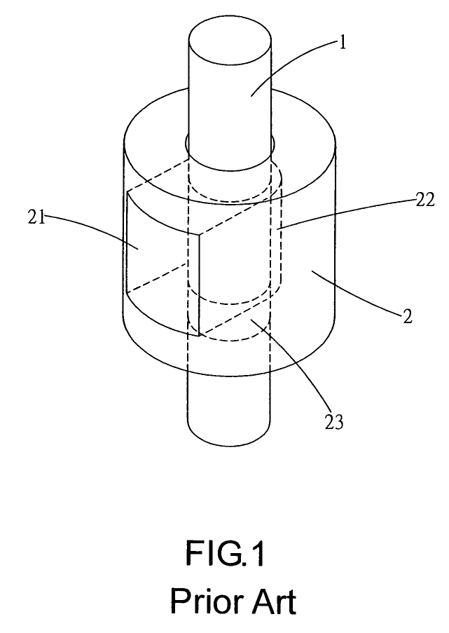

### DETAILED DESCRIPTION OF THE PREFERRED EMBODIMENTS

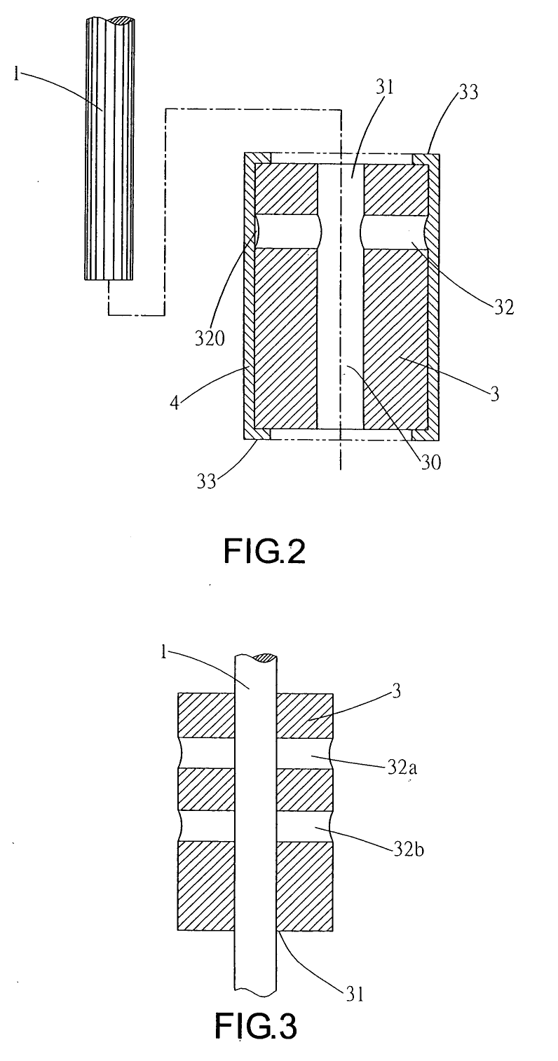

Referring to FIG. 2, which shows the present invention primarily comprising a single bearing 3, interior of which is longitudinally defined a shaft hole 31, which provides for a shaft 1 to be disposed therein. Symmetrically defined oil storage ports 32 radially penetrate an outer surface of the bearing 3. Because diameter of a cross-sectional area of each of the oil storage ports 32 is smaller then diameter of the shaft hole 31, thus, thus, a relatively large internal support surface 30 of the shaft hole 1 is presented to provide support for the shaft 1.

The ports 32 provide for lubricating oil to be stored therein, and transversely channel the oil to the shaft hole 31, thereby enabling the stored oil to be directly distributed onto the shaft 1. Moreover, a contact clearance between the shaft 1 and the shaft hole 31 forms a capillary effect that causes the oil to form a film that is distributed over an entire surface of t he internal support surface 30.

Outward port openings 320 of the oil storage ports 32 are sealed with end-seal members 4, thereby preventing the oil from leaking out. Any appropriate method is used to join the end-seal members 4 to the bearing 3, including an external casing method.

The ports 32 inwardly penetrate the bearing 3, and direction of penetration passes through a center line of the shaft hole 31. Referring to FIG. 3, the shaft hole 31 can completely penetrate the bearing 3, thereby enabling the bearing 3 to be used as a radial bearing. Because the shaft 1 has a specific length, thus a plurality of ports 32a, 32b can be defined on the bearing 3 in a longitudinally spaced distribution, thereby providing for a uniform discharge of an oil film on the shaft 1. Outer openings of the aforementioned ports 32a, 32b are sealed with the end-seal members 4 similar to that described for FIG. 2. The end-seal members 4 assume a hollow cylindrical form, dimensions of which exactly match those of the bearing 3, thereby encasing the entire bearing 3, and effectively sealing the oil within the shaft hole 31. Because top and bottom ends of the end-seal members 4 are respectively configured with a clasp 33, and the cross-sectional view of FIG. 2 shows that left and right sides respectively assume two inverted U shapes, thus, complete encasing of an exterior portion of the bearing 3 is achieved.

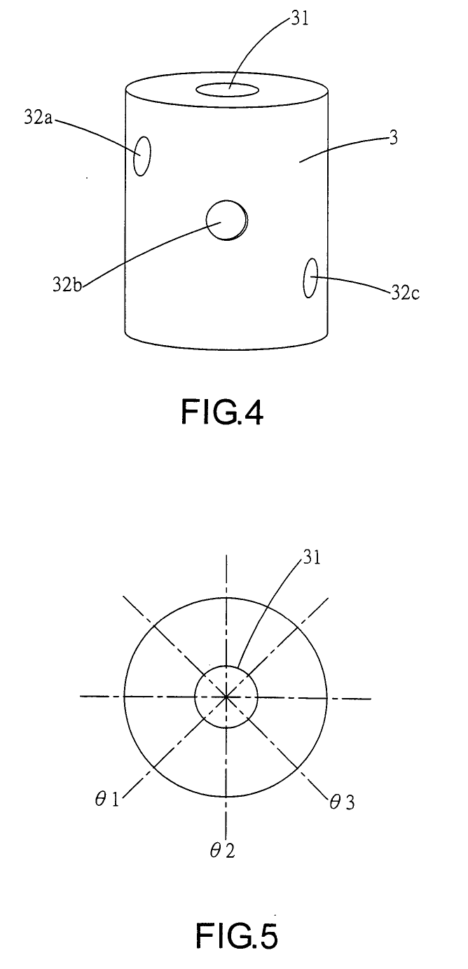

Referring to FIG. 3, which shows directions of penetration of the ports 32a and 32b passing through the center line of the shaft 1. FIG. 4 shows a plurality of the ports 32a, 32b, 32c defined on the bearing 3, which are distributed around the outer surface of the bearing 3 at different longitudinal positions and at staggered radial angles.

Referring to FIG. 5, the port 32a penetrates the bearing 3 at an angle θ1, the port 32b penetrates at an angle θ2, and the port 32c penetrates at an angle θ3, moreover, direction of penetration of each of the ports 32a, 32b, 32c passes through the center of the shaft hole 31. Hence, the plurality of staggered ports 32a, 32b, 32c defined at different longitudinal and angular positions around the outer surface of the bearing 3 are able to distribute a uniform oil film within the shaft hole 31.

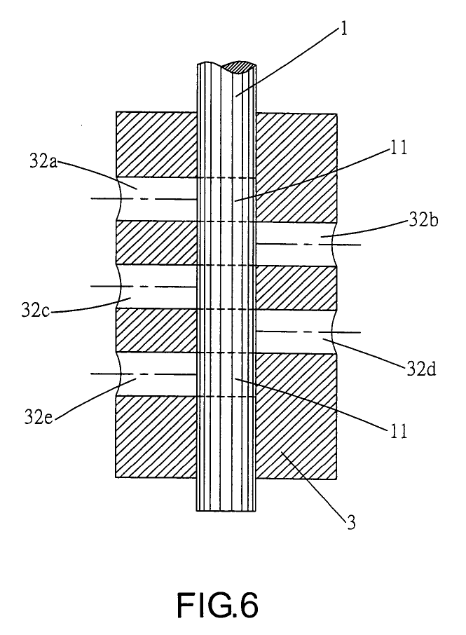

Referring to FIG. 6, in order to enable better distribution of the oil on contact surfaces 11 of the shaft 1, the ports 32a, 32b, 32c, 32d, 32e can be adjacently staggered at longitudinal positions or complementary positioned on the bearing 3. If the port 32a is defined as a highest positioned port along the bearing 3, then the port 32b is defined on another side from that of the port 32a lower down the bearing 3 so as to form a continuity of contact surfaces from the contact surface 11 of the port 32a to the contact surface 11 of the port 32b. Such a continuity of the contact surfaces 11 similarly continues between adjacent ports down to the lowest port 32e. An entire surface of the shaft 1 is thus made available for an oil film to be effectively applied between extreme ends thereon.

Design of the bearing 3 is that of a thrust bearing configured with the plurality of complementary ports 32a, 32b, 32c, 32d, 32e, that are contiguously aligned to form the continuity of contact surfaces 11. Moreover, the bearing 3 can also be used as a radial bearing, as depicted in FIG. 3.

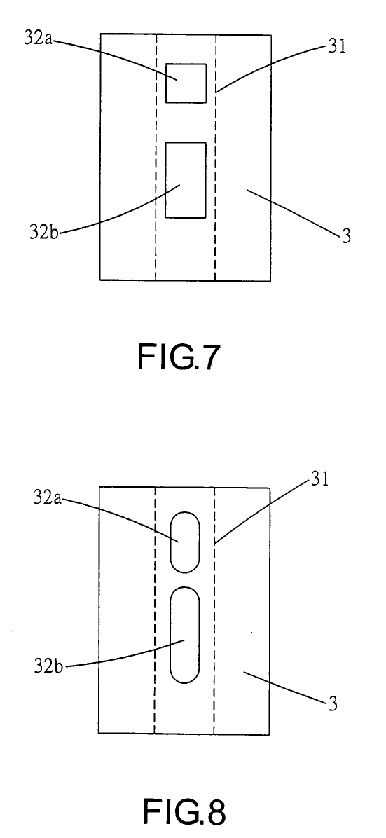

In addition to having a circular cross-section, FIG. 7 shows the ports 32a, 32b defined on the bearing 3 of the present invention having square or rectangular cross-sections. Moreover, width of each of the ports 32a, 32b is smaller than the diameter of the shaft hole 31, and the ports 32a, 32b can be defined at different heights along the body of the bearing 3 according to amount of oil required to be discharged to the shaft hole 31.

Referring to FIG. 8, which shows the ports 32a, 32b of the present invention further defined as elongated oval shapes to accord with production conditions and prevent stress concentration at the corners of ports having the rectangular shape, and different lengths of the ports 32a, 32b result in different amounts of oil being distributed to the shaft 1. Moreover, width of each of the ports 32a, 32b is smaller than the diameter of the shaft hole 31.

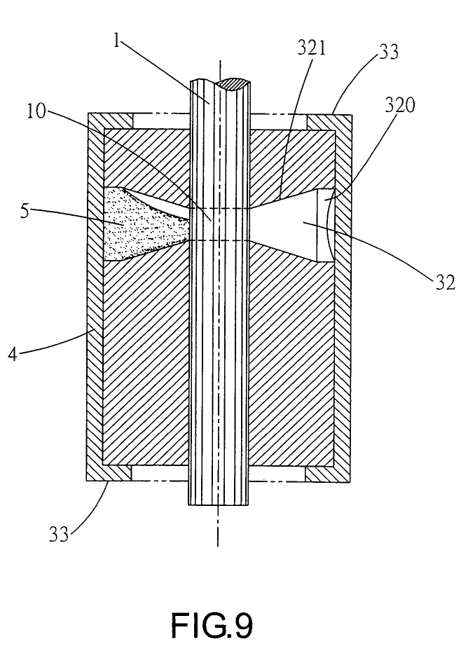

Referring to FIG. 9, which shows the ports 32 of the present invention providing for storage of bodies of oil 5 therein. When the shaft 1 is rotating at high speed, the centrifugal thrust from the rotating shaft 1 forces the bodies of oil 5 at contact surfaces 10 of the shaft 1 corresponding to the ports 32 outwards towards outer ends of the ports 32. Furthermore, inclined surfaces 121 of each of the ports 32 form a larger tapered outward expanded volume, which provides a yield space or compression space for the body of oil 5.

Under circumstances when the ports 32 are full or partially full with the bodies of oil 5, the centrifugal thrust formed by the high speed rotating shaft 1 outwardly forces the bodies of oil 5 towards the outer ends of the ports 32, thereby forming transitionary displacement spaces.

An outward facing opening 320 of each of the ports 32 can be sealed with the end-seal members 4, and direction of penetration of each of the ports 32 is inward and passes through the center line of the shaft hole 31.

The embodiments of the bearing 3 of the present invention are formed by using any CNC machining tool, injection molding or powder forging, and material used includes metal, various plastics or macromolecular industrial plastics. Because the basic structure of the present invention is designed so that the cross-sectional diameter of each of the ports 32 is smaller than the diameter of the shaft hole 31, thus, apart from enabling convenient machining and use of a multitude of methods to realize fabrication, moreover, the structure enables the internal surface of the shaft hole 31 to present a relatively larger support surface, thereby increasing overall mechanical strength of the bearing 3.

In conclusion, the oil carrying bearing of the present invention assuredly achieves described effectiveness as disclosed in the aforementioned configuration. Furthermore, contents of the present invention have not appeared in any publication or publicly disclosed prior to this application, and advancement and practicability of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An oil carrying bearing comprising an integrally formed single bearing, interior of which is defined a shaft hole, symmetrically defined oil storage ports radially penetrate an outer surface of the bearing, and direction of penetration of each of the oil storage ports passes through a center line of the shaft hole, width of a cross-sectional area of each of the oil storage ports is smaller than diameter of the shaft hole, and outward port openings of the oil storage ports are sealed with end-seal members.

2. The oil carrying bearing as described in claim 1, wherein the end-seal members assume a hollow cylindrical form, dimensions of which exactly match those of the bearing, top and bottom ends of the end-seal members are respectively configured with a clasp, and cross-section assumes an inverted U shape, thereby achieving complete encasing of an exterior portion of the bearing.

3. The oil carrying bearing as described in claim 1, wherein the ports have a circular cross-section.

4. The oil carrying bearing as described in claim 1, wherein the ports have an elongated oval cross-section.

5. The oil carrying bearing as described in claim 1, wherein the ports have a square cross-section.

6. The oil carrying bearing as described in claim 3, wherein the ports defined on the bearing are disposed in longitudinal arrangement on the bearing.

7. The oil carrying bearing as described in claim 4, wherein the ports defined on the bearing are disposed in longitudinal arrangement on the bearing.

8. The oil carrying bearing as described in claim 5, wherein the ports defined on the bearing are disposed in longitudinal arrangement on the bearing.

9. The oil carrying bearing as described in claims 3, wherein the ports are defined with outward expanding tapered inclined surfaces.

10. The oil carrying bearing as described in claims 4, wherein the ports are defined with outward expanding tapered inclined surfaces.

11. The oil carrying bearing as described in claims 5 wherein the ports are defined with outward expanding tapered inclined surfaces.

12. An oil carrying bearing comprising an integrally formed single bearing, interior of which is defined a shaft hole, symmetrically defined oil storage ports radially penetrate an outer surface of the bearing, and direction of penetration of each of the oil storage ports passes through a center line of the shaft hole, the ports are defined with outward expanding tapered inclined surfaces, width of a cross-sectional area of each of the ports is smaller than diameter of the shaft hole, and outward port openings of the oil storage ports are sealed with end-seal members.

13. The oil carrying bearing as described in claim 12, wherein the end-seal members assume a hollow cylindrical form, dimensions of which exactly match those of the bearing, top and bottom ends of the end-seal members are respectively configured with a clasp, and cross-section assumes an inverted U shape, thereby achieving complete encasing of an exterior portion of the bearing.

14. The oil carrying bearing as described in claim 12, wherein the ports have a circular cross-section.

15. The oil carrying bearing as described in claim 12, wherein the ports have an elongated oval cross-section.

16. The oil carrying bearing as described in claim 12, wherein the ports have a square cross-section.

17. The oil carrying bearing as described in claims 14, wherein the ports defined on the bearing are disposed in longitudinal arrangement on the bearing.

18. The oil carrying bearing as described in claims 15, wherein the ports defined on the bearing are disposed in longitudinal arrangement on the bearing.

19. The oil carrying bearing as described in claims 16, wherein the ports defined on the bearing are disposed in longitudinal arrangement on the bearing.
